(19) United States
(12) Patent Application Publication
(10) Pub. No.: US 2021/0041003 A1
(43) Pub. Date: Feb. 11, 2021

(54) Safe protection equipment for all vehicles and drivers

(71) Applicant: Qiusheng Gao, Cupertino, CA (US)

(72) Inventor: Qiusheng Gao, wujiang (CN)

(21) Appl. No.: 16/536,450

(22) Filed: Aug. 9, 2019

(51) Int. Cl. F16F 7/10

(52) U.S. Cl. CPC F16F 7/10; B60R 19/18

(57) ABSTRACT

Safe protection equipment for all vehicles will significantly reduce the collision force by elasticity of springs, tubes and stretchable material in that the springs, tubes or cubic bars with stretchable material will be deformed and compressed when the vehicle bumps to obstacle or two vehicles collide with each other. The reduced colliding force will be passed to the chassis by a frame that will move the vehicle forth or back. This equipment can be used on front, rear, side and corner of the vehicle. Combination of springs with stretchable bars can reduce the collision smoothly.

This equipment is attached to the vehicle chassis so the reduced collision force is passed to the vehicle chassis, while the current vehicle can reduce the collision force only by the deformation of the bumper or cover of the body. The remaining colliding force is directly passed to the body of the vehicle and could crash the body of the vehicle or injure the passengers when a heavy collision occurs without the safe protection equipment.

This equipment will protect both vehicles and drivers without changing the current air-bag protection system. It will significantly reduce the damage for serious collision accidents.

### TECHNICAL FIELD

The present invention generally relates to improvements in protecting both vehicles and drivers over collision accidents utilizing the elasticity of springs, tube and stretchy material from either front, rear, side and/or corner. The tubes will be deformed, spring and the stretchy material will be compressed to absorb the energy and reduce the colliding force when the vehicle hits an obstacle or collides with each other. The reduced colliding force will be passed to a frame of tubes or bars that is attached to the chassis of the vehicle. The chassis of the vehicle is almost incompressible. If the vehicle hits the obstacle, the vehicle could push the obstacle forward or the vehicle bumps back. If two vehicles hit each other, both vehicles could bump back or one vehicle pushes another vehicle forward.

There is no change for the current airbag protection system.

### BACKGROUND ART

Currently, most vehicles use airbag to protect the drivers in collision accidents. There is limitation with airbag protection. Airbag only protects driver, but not vehicle. When the vehicle hits an obstacle or collide with each other, the vehicle body and auto parts can be damaged. In case of heavy collision accident, not only the vehicles are seriously damaged, but also the drivers could be seriously injured or even killed due to the strong colliding force. Even in case the collision is not heavy, the vehicle body or auto parts are still damaged.

### SUMMARY OF THE INVENTION

An object of the present invention is to utilize the elasticity of springs, tube or bar made of stretchy material to absorb the energy and reduce the colliding force. Combination of springs with stretchy material can reduce the colliding force more smoothly and handle heavy collision better. The reduced colliding force is passed to the chassis from a frame of tubes or bars that is attached to the chassis. The current airbag protection system is not changed. Overall it will significantly reduce the damage for both vehicles and drivers in the collision accidents.

In accordance with the present invention, there are single or multiple tubes with stretchy material fixed to a frame of tubes or bars that is attached to the chassis of the vehicle. The outer tube is more stretchable than the inner tube is. The tubes with stretchy material can be replaced with cubic shape and the front cubic bar is more stretchable than the back cubic bar is. Multiple springs can be installed between two plates with sliding slots. Combination of springs and stretchable material can be installed between two plates with sliding slots.

In accordance with the present invention, when the vehicle hits an obstacle or collides with another vehicle, the tubes or cubic bars made of stretchy material or springs will be deformed and compressed to absorb the energy. The reduced colliding force will be passed to a frame of tubes or bars that is attached to the chassis of vehicle. If the collision is not heavy, there should be no any damage to both vehicle and driver. If the collision is heavy, it might cause the vehicle turning back. It might still trigger the vehicle to pop up the airbag. In any case, it will significantly reduce the damage to the vehicle and driver.

In accordance with the present invention, this equipment can be installed on front, rear, or side of the vehicle with similar design architecture. The equipment can be installed behind the existing bumper that might needs some design modification. Some vehicles might need to change the chassis and frame design to attach the equipment properly.

In accordance with the present invention, the equipment can have multiple tubes with different size. The outer tube will be deformed and compressed first. Such kind of combination will reduce the colliding force smoothly.

In accordance with the present invention, the equipment can have multiple cubic bars. The front cubic bar will be deformed and compressed first. Additional springs can be combined to the cubic bars. Such kind of combination will reduce the colliding force smoothly.

### BRIEF DESCRIPTION OF THE DRAWINGS

There are nine figures in the attached drawings.

FIG. 1 provides the 3-D view of the frame of tubes or bars that is fixed to the vehicle chassis on one end and has the stretchable tubes at front. The front frame has the semi-circle shape to adapt to the tube.

FIG. 2 provides the 3-D view of the multiple tubes. The outer tube is more stretchable than the inner tube.

FIG. 3 provides the vertical view of the safe protection equipment that is fixed to the vehicle chassis.

FIG. 4 provides the 3-D view of the frame of tubes or bars that is used to fix the stretchable cubic bars at front.

FIG. 5 provides the vertical view of the safe protection equipment that is fixed to the vehicle chassis on one end and has the springs and stretchable cubic bars at front.

FIG. 6 provides the 3-D view of the back plate that is used to fix the springs or cubic stretchable bars.

FIG. 7 provides the 3-D view of the front plate that is used to fix the springs or cubic stretchable bars.

FIG. 8 provides the 3-D view of 2 cubic stretchable bars. The front bar is more stretchable than the back bar.

FIG. 9 provides the 3-D view of 2 cubic stretchable bars with holes for springs.

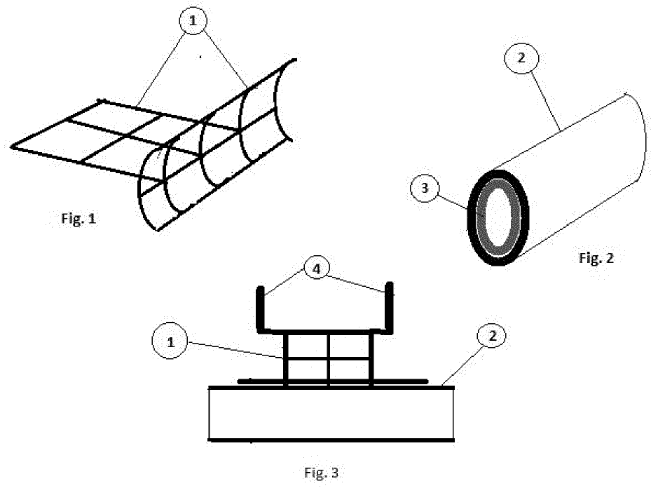

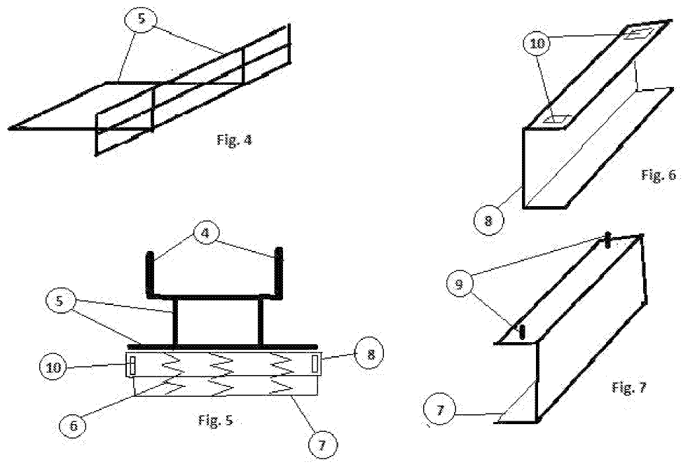

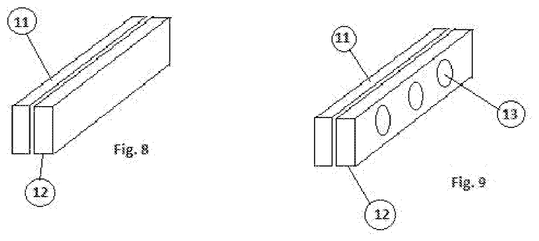

Following are the detailed information about the primary components of the equipment.
1. Tube or bar that constructs the frame with semi-circle shape at front to fix the stretchable tubes. The frame is attached to the chassis of vehicle.
2. Outer stretchable tubes. The material of the tubes can be sponge, rubber or similar stretchable material. Outer tube is more stretchable than the inner tube.
3. Inner stretchable tubes. The material of the tubes can be sponge, rubber or similar stretchable material.
4. The chassis of vehicle.
5. Tube or bar that constructs the frame to fix the cubic stretchable bars. The frame is attached to the chassis of vehicle.
6. Springs.
7. Front plate that fixes the springs or stretchable cubic bars.
8. Back plate that fixes the springs or stretchable cubic bars.
9. Rivets or metal pins.
10. Sliding slots.
11. Stretchable bar at back.
12. Stretchable bar at front.
13. Holes for springs.

### DETAILED DESCRIPTION OF PREFERRED EMBODIMENTS

This equipment can be applied to all type of vehicles, e.g., cars, vans and trucks. The material of the tubes (2) (3) or stretchable cubic bars (11) (12) needs to be sponge, rubber or similar stretchable material. The size of equipment needs further experiment based on the vehicle. The equipment can contain tubes (2) (3) with different size, the tube with big size will be deformed and compressed first. The equipment can also contain multiple stretchable cubic bars (11) (12), the cubic bar (12) at front will be compressed first. For some vehicles, the safe equipment can be installed behind the existing bumper while the bumper needs some modification. For some vehicles, the chassis (4) of the vehicle need some design change or strength enhancement.

When the vehicle hit an obstacle or two vehicles collide with each other in straight line or almost straight line, the bumper will push the outer tube (2) and inner tube (3). The tubes (2) (3) will be deformed and compressed to absorb the energy. If the tubes are replaced with cubic bars (11) (12), the front bar (12) will be compressed first, then the bar (12) behind the front bar will be compressed. If the tubes are replaced by springs (6), the front plate (7) will be pushed and move forward through the sliding slots (10). The front plate (7) will push the springs (6) and the springs (6) will be compressed. The springs (6) can also be combined with the stretchable cubic bars (11) (12). Both springs (6) and the stretchable bars (11) (12) will be compressed. During those processes, the compression of cubic bars (11) (12) and springs (6) will absorb the energy and reduce the colliding force.

The reduced colliding force will be passed to the chassis (4) by the frame (1) (5). If the colliding is very heavy, it will also trigger the vehicle to pop up the airbag. In any case, the damage of the vehicle and the driver from the collision accidents will be reduced significantly.

1. Safe equipment comprising:
single or multiple tubes
a frame (1) that is attached to the chassis (4) on one side and holds stretchable tubes (2) (3) on other side characterized in that a colliding force hitting on the outer tube (2) that push the inner tube (3) thereof the tubes (2) (3) will be deformed and compressed to absorb the energy and reduce the colliding force that is passed to the chassis (4) by the frame (1) and the reduced colliding force will move the vehicle forward or back hence significantly reduce the damage to the body of the vehicle and the passengers inside the vehicle in that the colliding force hitting on a bumper or side of the vehicle is passed to the body of a vehicle only with reduction by the deformation of the bumper or cover of the vehicle body.

2. The safe equipment as claimed in claim 1 with tubes (2) (3) replaced by stretchable cubic bars (11) (12) and frame (1) replaced by frame (5) and addition of plate (7) and (8) characterized in that a colliding force hitting on front plate (7) that push the cubic bars (11) (12) thereof the cubic bars (11) (12) will be deformed and compressed to absorb the energy and reduce the colliding force that is passed to the chassis (4) by the frame (1) and the reduced colliding force will move the vehicle forward or back hence significantly reduce the damage to the body of the vehicle and the passengers inside the vehicle in that the colliding force hitting on a bumper or side of the vehicle is passed to the body of a vehicle only with reduction by the deformation of the bumper or cover of the vehicle body.

3. The safe equipment as claimed in claim 2 with the cubic bars replaced by springs characterized in that a colliding force hitting on front plate (7) that push the springs (6) thereof the springs (6) will be compressed to absorb the energy and reduce the colliding force that is passed to the chassis (4) by the frame (1) and the reduced colliding force will move the vehicle forward or back hence significantly reduce the damage to the body of the vehicle and the passengers inside the vehicle in that the colliding force hitting on a bumper or side of the vehicle is passed to the body of a vehicle only with reduction by the deformation of the bumper or cover of the vehicle body.

4. The safe equipment as claimed in claims 2 and 3 with the cubic bars (11) (12) combined with springs (6) characterized in that the combination of cubic bars (11) (12) with springs (6) will reduce the colliding force smoothly and handle heavy collision better.

5. The safe equipment as claimed in claim 1 and/or 2 and/or 3 and/or 4 characterized in that the safe equipment can be applied to front and/or rear and/or side and/or corner of a vehicle.
